(19) United States
(12) Patent Application Publication
(10) Pub. No.: US 2026/0084622 A1
(43) Pub. Date: Mar. 26, 2026

(54) VEHICLE STORAGE BOX

(71) Applicant: HAYASHI TELEMPU CORPORATION, Nagoya-shi, Aichi (JP)

(72) Inventor: Yousuke USUI, Nagoya-shi, Aichi (JP)

(73) Assignee: HAYASHI TELEMPU CORPORATION, Nagoya-shi, Aichi (JP)

(21) Appl. No.: 19/109,318

(22) PCT Filed: Jul. 20, 2023
(86) PCT No.: PCT/JP2023/026551

§ 371 Date: Mar. 6, 2025

(30) Foreign Application Priority Data
Sep. 9, 2022 (JP) 2022-143528

(51) Int. Cl. B60R 5/04

(52) U.S. Cl. CPC B60R 5/04

(57) ABSTRACT

A vehicle storage box of the present invention, that is laid on a luggage compartment floor, includes an accommodating portion bounded by a bottom and a wall rising from the bottom in an upward direction of a vehicle, wherein the accommodating portion is provided with a partition protruding convexly from the bottom in the upward direction of the vehicle, wherein the bottom, the wall, and the partition are molded in one piece by stacking a base material made of a resin sheet and a skin material, and wherein the skin material faces a vehicle interior.

### TECHNICAL FIELD

The present invention relates to a vehicle storage box laid on a luggage compartment floor of a vehicle.

### BACKGROUND ART

On the luggage compartment floor (e.g. trunk room) of a vehicle such as a passenger car, a spare tire and other equipment (tools, a warning triangle, etc.), as well as various belongings of users, are stored. For this purpose, a vehicle storage box for storing various equipment and users'belongings (hereinafter referred to as stored items) is laid on the vehicle panel that constitutes the luggage compartment floor. The vehicle storage box is required to have the necessary usability and rigidity to function as a storage box. In addition, the vehicle storage box desirably has a well-designed surface that faces the vehicle interior. Furthermore, the vehicle storage box may also be required to function to prevent sound and heat from being transmitted from outside to inside the vehicle.

For example, Patent Literature 1 discloses a luggage storage unit with three storage boxes combined to be laid across the entire luggage compartment floor of a vehicle. Materials and manufacturing methods for vehicle interior components with high design quality, which are laid on the luggage compartment floor of a vehicle, are disclosed in, for example, Patent Literatures 2 and 3.

### CITATION LIST

### Patent Literature

Patent Literature 1: JP 7032960 B

Patent Literature 2: JP 6937185 B

Patent Literature 3: JP 4630155 B

### SUMMARY OF INVENTION

### Technical Problem

To function as a storage box, the vehicle storage box must be provided with a partition to divide the storage area and hold the stored items. For example, a sheet-like fiber material (such as felt) or a bead foam (commonly known as polystyrene foam) can be used to mold the vehicle storage box including the partition in one piece. However, since the partition made of fiber material is not strong enough, a member such as hard resin must be additionally used as a separate partition part. The separate partition part has the advantage of changing where the storage area is divided but requires an additional processing cost to assemble the partition part into the vehicle storage box.

In addition, if the partition part is hard, when the stored items come into contact with the partition part due to vehicle vibrations, abnormal noise could occur, or the stored items could be damaged. Bead foam is lightweight and has cushioning properties, and therefore is less likely to generate abnormal noise or damage the stored items. However, the vehicle storage box made with bead foam needs to be formed thicker to achieve the required strength, which reduces the volume for accommodation.

Furthermore, as described above, the vehicle storage box desirably has a well-designed surface that faces the vehicle interior. To improve the design quality, it is conceivable that, for example, a sheet-like skin material made of synthetic resin is used to form the vehicle storage box.

However, since the skin material alone does not provide the partition with the necessary strength, a member such as hard resin must be additionally used as a separate partition part in this case as well. If the partition part made with a hard member is provided, a part made of a material different from the skin material will be assembled into the vehicle storage box, which leads to a loss of unity and thus a decrease in design quality. On the other hand, if the partition part is not used to divide the storage area, the vehicle storage box will not be able to hold the stored items, thus reducing the usability of the vehicle storage box.

Patent Literature 1 does not propose to use a skin material for the luggage storage unit (i.e. vehicle storage box). Patent Literatures 2 and 3 propose the vehicle interior components with a skin material (i.e. skin layer), but do not suggest anything about the shape and structure of the vehicle storage box.

It is an object of the present invention to solve the problems of the background art as described above, and to provide a vehicle storage box with high design quality that requires no additional parts.

### Solution to Problem

To achieve the above object, a vehicle storage box of the present invention, that is laid on a luggage compartment floor, includes an accommodating portion bounded by a bottom and a wall rising from the bottom in an upward direction of a vehicle, wherein the accommodating portion is provided with a partition protruding convexly from the bottom in the upward direction of the vehicle, wherein the bottom, the wall, and the partition are molded in one piece by stacking a base material made of a resin sheet and a skin material, and wherein the skin material faces a vehicle interior.

### Advantageous Effects of Invention

According to the present invention, a vehicle storage box with high design quality that requires no additional parts is obtained.

### BRIEF DESCRIPTION OF THE DRAWINGS

FIG. 1 is a perspective view showing an exemplary configuration of a vehicle storage box of the present invention;

FIG. 2 is a side cross-sectional view of the vehicle storage box shown in FIG. 1;

FIG. 3 is a cross-sectional view of an example of a sheet member used to manufacture the vehicle storage box shown in FIGS. 1 and 2; and

FIG. 4 is a side cross-sectional view of an example of accommodating recesses defined by a partition of the vehicle storage box shown in FIGS. 1 and 2.

### DESCRIPTION OF EMBODIMENTS

The present invention will be described below using the drawings.

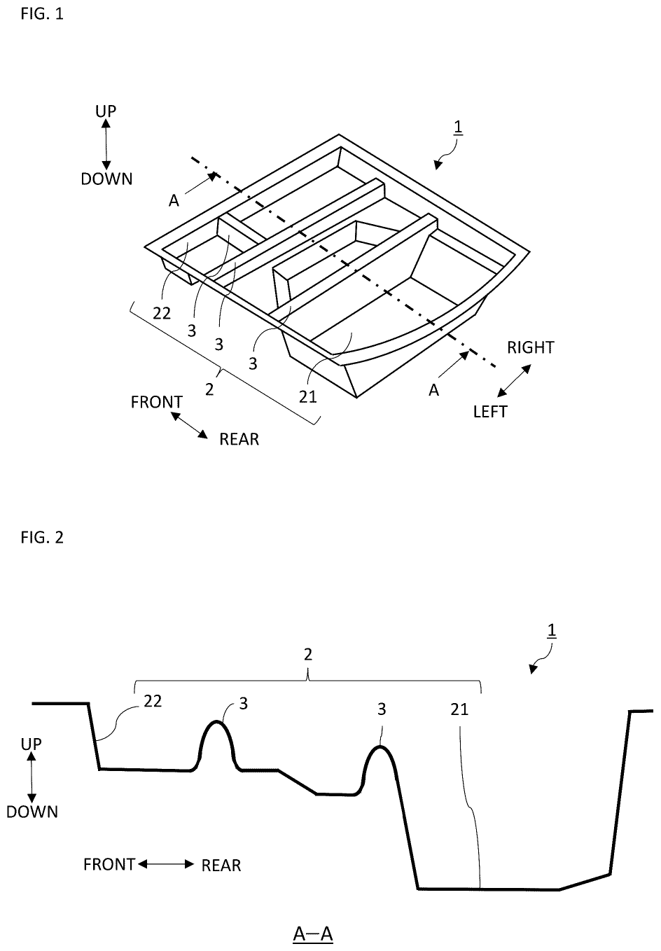

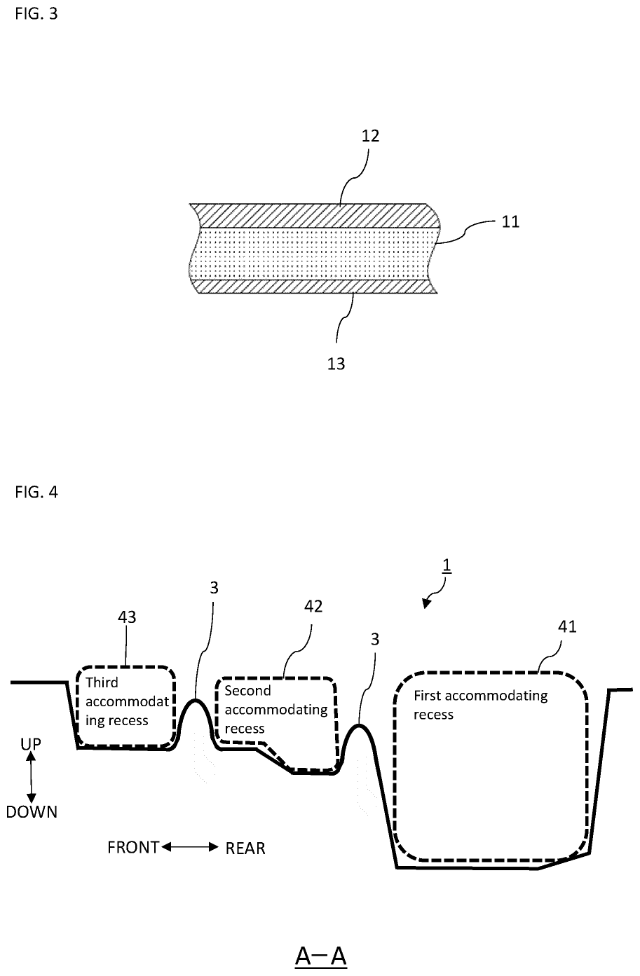

FIG. 1 is a perspective view showing an exemplary configuration of a vehicle storage box of the present invention. FIG. 2 is a side cross-sectional view of the vehicle storage box shown in FIG. 1. FIG. 3 is a cross-sectional view showing an example of a sheet member used to manufacture the vehicle storage box shown in FIGS. 1 and 2, and FIG. 4 is a side cross-sectional view showing an example of accommodating recesses defined by a partition of the vehicle storage box shown in FIGS. 1 and 2.

FIGS. 2 and 4 schematically show the cross-section of the vehicle storage box taken at a position corresponding to line A-A shown in FIG. 1. FRONT, REAR, LEFT, RIGHT, UP, and DOWN shown in FIG. 1 indicate the front, rear, left, right, upward, and downward directions of the vehicle, respectively. The positional relationship between the left and right directions is based on the front direction of the vehicle. Similarly, FRONT, REAR, UP, and DOWN shown in FIGS. 2 and 4 also indicate the front, rear, upward, and downward directions of the vehicle, respectively. FIGS. 1 to 4 schematic show the constituent elements of the invention, and do not accurately illustrate the dimensions, shape, structure, position, etc. of the constituent elements.

As shown in FIGS. 1 and 2, vehicle storage box 1 of the present invention includes accommodating portion 2 bounded by bottom 21 and wall 22 rising from bottom 21 in the upward direction of the vehicle, wherein accommodating portion 2 is provided with partition 3 protruding convexly from bottom 21 in the upward direction of the vehicle. Partition 3 is intended to divide the storage area of accommodating portion 2 and hold the stored items, as described above. Vehicle storage box 1 of the present invention shown in FIGS. 1 and 2 is configured such that bottom 21, wall 22, and partition 3 are molded in one piece from a resin sheet member. Vehicle storage box 1 is placed on the luggage compartment floor located behind the vehicle seat (e.g. rear seat).

A resin sheet member is thus made into a single molded piece including partition 3, so that there is no need for a separate partition part and no additional processing cost to assemble the partition parts into mold vehicle storage box 1. In addition, the provision of partition 3 allows the stored items to be held and does not reduce the usability as a storage box. Furthermore, the one-piece molding of vehicle storage box 1 eliminates gaps between storage boxes, compared to a configuration with multiple storage boxes, thus preventing sound and heat from being transmitted from outside to inside the vehicle.

As shown in FIG. 3, a sheet member used to manufacture vehicle storage box 1 is configured by stacking base material 11 made of a resin sheet, skin material 12, and a non-woven fabric 13 placed on the side of base material 11 opposite to skin material 12. Vehicle storage box 1 is molded so that skin material 12 faces the vehicle interior. Base material 11 is, for example, a sheet made of PP (polypropylene). Skin material 12 is, for example, a non-woven fabric, such as a plain needle punched non-woven fabric or a dilour needle punched non-woven fabric, made of synthetic resin fibers. Skin material 12 may be natural leather or synthetic leather. Non-woven fabric 13 may not be provided.

Vehicle storage box 1 of the present invention is molded from a relatively thin sheet member obtained by stacking base material 11, skin material 12, and non-woven fabric 13, which eliminates the need to form it thickly as in the use of bead foam and does not reduce the volume for accommodation. Skin material 12 that faces the vehicle interior has a more premium feel compared to a hard resin material or a bead foam and is integrated into a single molded piece including partition 3, thus obtaining vehicle storage box 1 with a sense of unity and high design quality. In addition, skin material 12 has sound-absorbing and heat-insulating effects, thus preventing sound and heat from being transmitted from outside to inside the vehicle.

Furthermore, base material 11 made of resin becomes harder after molding, so that accommodating portion 2, including partition 3 that has the necessary strength for a storage box, can be obtained. On the other hand, base material 11 is more easily deformable than hard resin, thus obtaining partition 3 with cushioning properties. In addition, skin material 12 is stacked on base material 11 to face the vehicle interior, thus reducing the noise generated when the stored items come into contact with partition 3 and also reducing the possibility of damage to the stored items.

As shown in FIG. 4, accommodating portion 2 includes at least two accommodating recesses 4, defined by at least one partition 3, which together serve as a storage area for the stored items. Partition 3 is formed along the width direction (i.e. left-right direction) of the vehicle. FIG. 4 shows an example of vehicle storage box 1 in which three accommodating recesses 4 (i.e. first accommodating recess 41, second accommodating recess 42, and third accommodating recess 43) are arranged in the front-rear direction of the vehicle, defined by two partitions 3 formed along the width direction of the vehicle. Partition 3 may be further formed along the front-rear direction of the vehicle to divide one accommodating recess 4 into multiple accommodating recesses 4, as in the case of accommodating recess 4 located on the vehicle front side shown in FIG. 1.

In the present invention, among multiple accommodating recesses 4, bottom 21 of accommodating recess 4 located on the most vehicle front side (i.e. third accommodating recess 43 in FIG. 4) is positioned on the more vehicle upper side than bottoms 21 of accommodating recesses 4 located on the vehicle rear side (i.e. first accommodating recess 41 and second accommodating recess 42 in FIG. 4). In other words, in vehicle storage box 1 of the present invention, multiple accommodating recesses 4 are formed to gradually become shallower from the vehicle rear side toward the vehicle front side so that accommodating recess 4 located on the most vehicle rear side is the deepest and accommodating recess 4 located on the most vehicle front side is the shallowest.

In general, on the luggage compartment floor, the stored items in accommodating recess 4 on the vehicle rear side are easy to see even if it is deep, whereas the stored items in accommodating recess 4 on the vehicle front side are difficult to see if it is deep. In the present invention, as shown in FIG. 4, accommodating recess 4 on the vehicle front side (i.e. third accommodating recess 43) is formed to be the shallowest, so that the stored items in said accommodating recess 4 are easy to see and take out. Therefore, the usability of vehicle storage box 1 is improved.

For example, in the event that the vehicle is rear-ended by another vehicle, even if the stored items in shallowly formed third accommodating recess 43 on the vehicle front side are thrown forward, they are less likely to hit the occupants because of being blocked by the seat backrest. On the other hand, if first accommodating recess 41 on the vehicle rear side is shallow, there is a risk that the stored items thrown forward out of it may reach the passenger compartment over the seat backrest and hit the occupants. Therefore, multiple accommodating recesses 4 are formed to gradually become shallower from the vehicle rear side toward the vehicle front side, which reduces the possibility of the stored items hitting the occupants in the event of a rear-end collision while improving the visibility and ease of taking out the stored items.

Furthermore, in the event that the vehicle is rear-ended by another vehicle, if a separate partition part is provided and multiple accommodating recesses 4 on the vehicle rear and front sides have the same depth, the impact of a rear-end collision will be transmitted directly to the seat through vehicle storage box 1. In that case, the occupant of said seat may be at risk of injuries such as cervical sprains (commonly known as whiplash). Vehicle storage box 1 of the present invention is configured such that the energy of a rear-end collision is absorbed by multiple accommodating recesses 4 of different depths arranged in the front-rear direction of the vehicle and partition 3 formed convexly along the width direction of the vehicle, thus reducing the impact of a rear-end collision transmitted to the seat through vehicle storage box 1.

On the vehicle lower side of accommodating recess(es) 4, among multiple accommodating recesses 4 shown in FIG. 4, that is/are shallowly formed (i.e. third accommodating recess 43, or both second accommodating recess 42 and third accommodating recess 43, in FIG. 4), electronics such as batteries, motors, converters, inverters, etc. may be placed. Even when electronics such as motors, converters, and inverters, etc. are placed on the vehicle lower side of accommodating recess(es) 4 in this way, the sound-absorbing effect of skin material 12 prevents abnormal noise generated by the electronics from leaking into the vehicle interior. For this case, skin material 12, base material 11, and non-woven fabric 13 may each be mixed with a material that blocks electromagnetic waves so that electromagnetic waves generated by the electronics are blocked. This can reduce the impact of electromagnetic waves generated by the electronics on the vehicle lower side on mobile phones and medical devices used in the vehicle interior. The electronics may be placed on the vehicle lower side of accommodating recess 4, among multiple accommodating recesses 4, that is formed to the deepest (i.e. first accommodating recess 41 in FIG. 4).

Vehicle storage box 1 of the present invention includes accommodating portion 2 bounded by bottom 21 and wall 22 rising from bottom 21 in the upward direction of the vehicle, wherein accommodating portion 2 is provided with partition 3 protruding convexly from bottom 21 in the upward direction of the vehicle, and wherein bottom 21, wall 22, and partition 3 are molded in one piece from a resin sheet member. Therefore, additional parts such as a partition part are not required.

A resin sheet member used to manufacture vehicle storage box 1 of the present invention is configured by stacking base material 11 made of a resin sheet and skin material 12 and is placed so that skin material 12 faces the vehicle interior. Skin material 12 that faces the vehicle interior has a more premium feel compared to a hard resin material or a bead foam and is integrated into a single molded piece including partition 3, thus obtaining vehicle storage box 1 with a sense of unity and high design quality because it is not assembled from parts made of different materials. Therefore, according to the present invention, vehicle storage box 1 with high design quality that requires no additional parts is obtained.

1. A vehicle storage box laid on a luggage compartment floor, comprising, an accommodating portion bounded by a bottom and a wall rising from the bottom in an upward direction of a vehicle,
wherein the accommodating portion is provided with a partition protruding convexly from the bottom in the upward direction of the vehicle,
wherein the bottom, the wall, and the partition are molded in one piece by stacking a base material made of a resin sheet and a skin material, and
wherein the skin material faces a vehicle interior.

2. The vehicle storage box according to claim 1, wherein the accommodating portion includes at least two accommodating recesses defined by the at least one partition.

3. The vehicle storage box according to claim 2,
wherein the partition is formed along a width direction of the vehicle, and
wherein among the at least two accommodating recesses, a bottom of an accommodating recess located on a vehicle front side is positioned on a more vehicle upper side than a bottom of an accommodating recess located on a vehicle rear side.

4. The vehicle storage box according to claim 3, further comprising the partition formed along a front-rear direction of the vehicle.

5. The vehicle storage box according to claim 2, wherein electronics are placed on a vehicle lower side of an accommodating recess, among the at least two accommodating recesses, that is shallowly formed.
